(19) United States
(12) Patent Application Publication
(10) Pub. No.: US 2006/0066127 A1
(43) Pub. Date: Mar. 30, 2006

(54) Method of manufacturing a panel assembly and panel assembly

(75) Inventors: Yasuhiro Shibuya, Chita-gun (JP); Francois Moonens, Jumet (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 11/274,162

(22) Filed: Nov. 16, 2005

Related U.S. Application Data
(63) Continuation of application No. PCT/JP04/06789, filed on May 13, 2004.

(30) Foreign Application Priority Data
May 16, 2003 (EP) 03101392

(51) Int. Cl. B60J 1/00; B32B 7/00; B65C 9/25

(52) U.S. Cl. 296/84.1; 156/310; 156/320

(57) ABSTRACT

A panel assembly including a panel (2) and a gasket (1) bonded on a surface (8) of said panel, said assembly having a linear bonding strength of said gasket on said panel which is higher than 35 N/cm, and being obtained by a method which comprises coating a preformed thermoplastic gasket (1) with a film (3) of a priming composition, coating a panel (2) with another film (10) of a priming composition, heating the film (3) on the gasket (1), heating the film (10) on the panel (2) and bringing said gasket (1) into contact with said panel (2).

### FIELD OF THE INVENTION

The present invention relates to panel assemblies, such as glass or similar panel assemblies specially adapted for use as windows in vehicles, buildings or other structures.

The invention relates more specifically to a method for manufacturing such panel assemblies.

Panel assemblies generally comprise a panel with a gasket bonded to a surface of the panel. In the car industry new styling requirements in vehicle glass panel assemblies are demanding flush mounted glass panels having an exposed edge.

### BACKGROUND OF THE INVENTION

Window assemblies intended for use in flush mounted applications has a gasket moulded directly to a surface of a panel in a moulding machine. Such panel assemblies have disadvantages notably with respect to the difficulties of having gaskets having undercuts or lips.

In EP-A-0 576 180 a method for the manufacture of a panel assembly is described, which comprises bringing a preformed thermoplastic gasket into contact with a panel, a priming composition being interposed between both the gasket and the panel and subjected to heating. In more details the method proposed in EP-A-0 576 180 comprises providing a panel and a preformed gasket, supporting the preformed gasket on a support (e.g. a mould) with a bonding surface of this gasket facing a portion (e.g. a peripheral portion) of the panel, coating said bonding surface of the gasket and/or said portion of the panel with a film of a priming composition, bringing (generally forcing with pressure) the panel into contact with the gasket, and subsequently heating the contact boundary between the panel and the gasket to bind the gasket and the panel thereby forming the panel assembly. Alternatively this known method comprises in addition heating the panel with the priming composition film thereon before bringing the panel into contact with the gasket.

In this known method the step of heating the contact boundary between the panel and the gasket is not easy and generally necessitates heating the assembly of both the gasket and the panel. Heating this assembly is detrimental to the physical properties of the gasket. It may further be detrimental to the panel particularly in case of laminated glass panels for vehicles (as it is now normally the case for car windscreens). Using a lower heating temperature could of course reduce the risk of damage to the gasket or the panel but this will be detrimental to the mechanical properties of the assembly, particularly the adhesive strength of the gasket to the panel.

### SUMMARY OF THE INVENTION

Accordingly it is an object of this invention to overcomes these prior art problems.

It is more particularly an object of this invention to provide an improved panel assembly including a panel and a gasket bonded to the panel, wherein the mechanical properties of the assembly are improved particularly the adhesive strength of the gasket to the panel.

Another object of the invention is to provide an improved car glass panel assembly particularly an improved strengthened glass panel assembly, having improved mechanical properties.

A specific object of this invention is to provide a method of manufacturing such a panel assembly, particularly an improved method which prevent any damage to either the gasket or the panel without detrimental effect to the mechanical strength of the assembly (particularly the adhesive strength of the gasket to the panel).

Accordingly the present invention relates to a method of manufacturing a panel assembly comprising bringing a preformed thermoplastic gasket into contact with a panel, a priming composition being interposed between both the gasket and the panel and subjected to heating, said method being characterised in that said priming composition comprises a film of priming composition which is coated on the gasket and a film of priming composition which is coated on the panel, and in that said heating is performed in two separate steps before bringing said gasket into contact with said panel, said steps comprising a step of heating said film of priming composition on the gasket and a step of heating said film of priming composition on the panel.

In the method according to the invention a panel is by definition an object having a large surface area as compared to its thickness. More particularly the panel has generally two substantially parallel sides or faces with a length and a width which each are many times (usually more than 10 times and more usually more than 50 times) longer than its thickness. The panel used in this invention may be any panel adapted to have a gasket bonded thereon. It may be made in any material compatible with the bonding of a resilient gasket thereon and may for example comprise any transparent or opaque panels, panels made of soft plastic, panels made of rigid plastic, glass panels, tempered glass panels, laminated glass panels or any otherwise strengthened glass panels (this enumeration being not a limitation of the scope of this invention). The invention is advantageously directed to glass panels as usually used as windows in buildings, houses and vehicles, particularly car vehicles, railway wagons and airplanes.

The shape of the panel is not critical. It may be either plane and uniform or bent or curved as it is usually the case with car windows and windscreens.

The panel may possibly be coated with a ceramic frit layer on its bonding face portion, as it is usual in the car industry.

The gasket acts as an impervious and/or decorative element when the panel is assembled into a frame or another appropriate support for example into a car-body. The profile of the gasket is not critical and can be for example a peripheral gasket of the panel.

The gasket is made of a resilient material which is advantageously water- and/or air-proof. It is preferably made of a thermoplastic material, more preferably a thermoplastic elastomer. Thermoplastic chlorinated polymers and copolymers and thermoplastic olefinic polymers and copolymers are convenient. Preferred chlorinated polymers and copolymers comprise polymers and copolymers of vinyl chloride, polyvinyl chloride (PVC) being more preferred. Preferred olefinic polymers and copolymers comprise polymers and copolymers of ethylene, propylene and butylene. Polymers and copolymers of the ethylene-propylene-diene-monomer type (EPDM) are more preferred.

The method of manufacturing the gasket is not critical. It can, for example, be formed by moulding, injection moulding or extrusion.

In the method according to the invention, priming composition denotes a composition adapted to adhere to both the panel surface and the gasket after heating in order to realize an efficient bonding of the gasket to the panel. Priming compositions are well known in the art of manufacturing glass panel assemblies. The most efficient priming composition will depend on different factors, particularly on the material of the gasket, on the material of the panel and on the purpose of the panel assembly. Suitable priming compositions-include chlorinated olefinic polymers and copolymers and epoxy resin systems. Preferred chlorinated olefinic polymers and copolymers include chlorinated polypropylene. The priming composition is generally liquid and include an organic solvent.

In the invention method, a priming composition is coated on both the panel and the gasket in two separate steps. In more details the gasket has a surface portion which has to be brought into contact with a surface portion of the panel. Before bringing said surface portion of the gasket into contact with said surface portion of the panel, a film of a priming composition is coated on said surface portion of the panel, and another film of a priming composition is coated on said surface portion of the gasket.

A film of priming composition is generally a coating having a very small depth of some micrometers, preferably less than 100 μm, more preferably less than 50 μm and even more preferably less than 20 μm, a depth of 2 to 10 μm being generally convenient, this depth being the depth of the coating in a dry state after elimination of its solvent (if any).

The method of coating a film of priming composition on the surface portion of the panel and on the surface portion of the gasket should be chosen in order to avoid any modification of the intrinsic physical and chemical properties of the priming composition, panel surface and gasket. Brushing and pulverizing a liquid priming composition are preferred methods. Usually liquid priming compositions adapted for the brushing or pulverizing coating methods include a solvent, generally an organic solvent.

In the method according to the invention the priming composition which is coated on the gasket may be either the same as or different than the priming composition which is coated on the panel. It is preferred to have a same priming composition coated on both the gasket and the panel.

In a particular embodiment of the method according to the invention the panel is advantageously cleaned and degreased before depositing thereon the film of priming composition. Similarly the gasket is preferably cleaned and degreased before coating with the film of priming composition.

According to the invention the film of priming composition which is coated on the panel and the film of priming composition which is coated on the gasket are both heated before bringing the gasket into contact with the panel.

Heating the film of priming composition on the gasket acts as evaporating the solvent (if any) of the film and promoting a mutual interaction between molecules of the film and molecules of the surface portion of the gasket, which induces an adhesive strength of the film to the gasket surface. Temperature and time of heating will depend on several factors such as the material of the gasket, the priming composition and the depth of the film on the gasket. Optimum temperature and time of heating have thus to be determined by routine tests in a lab. Generally temperatures ranging between 80 to 250° C. are convenient in most cases, temperatures of from 100 to 200° C. being preferred, temperatures of from 150 to 180° C. being more preferred.

When heating the film of priming composition on the gasket it is preferred to avoid heating of the core of the gasket, in order to avoid any modification or damage to the shape and physical (mechanical) properties of the gasket. Heating the film on the gasket may thus to be strictly limited to the film of priming composition and to the surface portion of the gasket, this surface portion being generally limited to a depth of some micrometers, preferably less than 100 μm, more preferably less than 50 μm and even more preferably less than 20 μm, a depth of 2 to 10 μm being generally convenient. Methods and apparatus used to heat the film of priming composition on the gasket surface has thus to be selected in order to heat the entire depth of the film as well as said surface portion of the gasket, as defined hereabove. A preferred method consists in sweeping the film with a stream of a hot gas (preferably hot air) during sufficient time to realize the required temperature through the film and said surface portion of the gasket.

Similarly heating the film of priming composition on the panel acts as evaporating the solvent (if any) of the film and may promote an adhesive strength of the film to the panel surface. Temperature and time of heating will depend on several factors particularly the priming composition and the depth of the film on the panel. Optimum temperature and time of heating have thus to be determined by routine tests in a lab. Generally temperatures ranging between 50 to 200° C. are convenient in most cases, temperatures of from 75 to 160° C. being preferred, temperatures of from 75 to 120° C. being more preferred. The method to heat the film of priming composition on the panel is not critical. Adequate methods include heating the panel in a magnetic induction furnace, in a furnace heated by electromagnetic radiations (i.e. infra-red radiations) or in a heat-convection type furnace (for example a tunnel furnace)or by application of a stream of hot air.

In the method according to the invention after both the gasket and the panel have been heated as explained hereabove said surface portion of the gasket which has been coated with a film of priming composition is brought into contact with said surface portion of the panel which has been coated with a film of priming composition. In this step of the method according to the invention the film of priming composition on the panel should preferably be at high temperature, substantially the same as the temperature at the end of the step of heating said film on the panel. For this end bringing the panel into contact with gasket is preferably executed just after the end of the step of heating the panel with the film of priming composition thereon.

It is possible according to a particular embodiment of the method according to the invention to subject the film of priming composition to cooling on the gasket before bringing the gasket into contact with the panel. In this embodiment of the invention, “to subject the film to cooling” denotes to let the film naturally cool within the surrounding atmospheric air, or treating the film with a controlled (or uncontrolled) cooling means such as a refrigerator or a flow of air or another gas under controlled or uncontrolled flow rate and/or temperature. This embodiment of the method according to the invention has the advantage to prevent any damage to the physical and mechanical properties of the gasket during the step of bringing the gasket into contact with the panel. It has the additional advantage to allow the possibility to dissociate the step of heating the film of priming composition on the gasket from the step of bonding said gasket on the panel and allows for example stocking gaskets with a preheated priming composition thereon before bonding on a panel. The cooling may be at a temperature of from substantially 10 to substantially 30° C., preferably from 15 to 25° C. Ambient atmospheric temperature is advantageous.

In another particular embodiment of the method of this invention said bringing of the gasket on the panel comprises forcing with pressure the panel into contact with the gasket. Pressures of from 0.10 to 1.50 Mpa are convenient, pressures of from 0.20 to 1.00 Mpa being preferred, pressures of from 0.30 to 0.60 Mpa being more preferred.

The method according to the invention allows the manufacture of panel assemblies which combine a series of advantageous properties which, before the invention, were considered as incompatible with one another. In particular in panels assemblies obtained by means of the method according to this invention the sealing join of the panel to the gasket is improved by comparison with the sealing join of panel assemblies of the prior art without any detrimental effect on the shape, profile and mechanical properties of the gasket and the panel.

In particular the method according to the invention allows the manufacture of panel assemblies having a more efficient bonding of the gasket to the panel without detrimental effect on either the gasket or the panel.

More particularly the method according to the invention allows the manufacture of laminated glass panel assemblies (such as laminated car windscreens) having a more efficient bonding of the gasket to the panel without detrimental effect on the glass laminated panel assembly.

The method according to the invention is adapted to the manufacture of any panel assemblies. It is well adapted to the manufacture of glass panel assemblies, particularly glass panel assemblies for use in vehicles, more particularly strengthened car glass assemblies and even more particularly tempered car glass windows and laminated car glass windscreens. The method of manufacturing according to the invention finds a particular and advantageous application in the manufacture of flush mounted glass panels.

According to another aspect of the present invention there is thus provided a panel assembly including a glass panel and a gasket made of a thermoplastic elastomers material bonded on a surface of said glass panel, said panel assembly being characterized by a linear bonding strength of said gasket on said panel which is higher than 35 N/cm.

Linear bonding strength of the gasket on the glass panel denotes the force applied at the end of a gasket of 1 cm width and directed perpendicularly to the panel surface, which is necessary to detach said gasket from said panel by peeling, said force and peeling of the gasket being displaced perpendicularly to the panel with a speed of substantially 300 mm/min.

Panel assemblies according to the invention with a linear bonding strength of the gasket to the glass panel of more than 35 N/cm may advantageously be obtained by means of the method according to the invention just described hereabove.

Preferred panel assemblies according to the invention have said linear bonding strength of the gasket to the glass panel at least equal to 38 (more preferably 40) N/cm. In specially advantageous panel assemblies according to the invention said linear bonding strength of the gasket to the glass panel is of from 40 to 80 N/cm.

The thermoplastic material of the gasket may advantageously be selected from amongst the olefinic thermoplastic polymers, the olefinic thermoplastic copolymers, the chlorinated thermoplastic polymers and the chlorinated thermoplastic copolymers. Resilient thermoplastic materials including a polymer or copolymer of vinyl chloride are preferred, specifically polyvinyl chloride and polyvinylidene chloride. Another preferred group of suitable resilient thermoplastic materials includes an elastomer selected from amongst the copolymers of the ethylene-propylene-diene-monomer type.

### BRIEF DESCRIPTION OF THE DRAWINGS

Details and features of the present invention will become apparent to those skilled in the art from the following detailed description of a preferred embodiment of the method according to the invention when considered in the light of the accompanying drawings in which:

FIGS. 1 to 7 are schematic cross-sectional view of the successive steps of manufacturing a panel assembly according to this invention, using the method according to this invention.

In these figures same reference numerals denote same components.

### DETAILED DESCRIPTION OF A PREFERRED EMBODIMENT

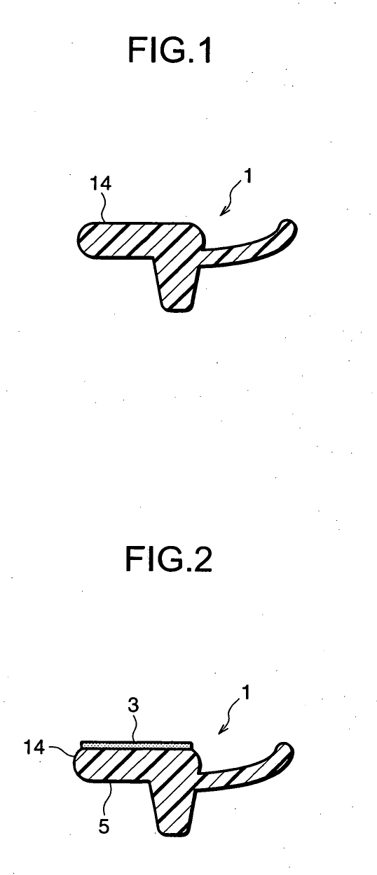

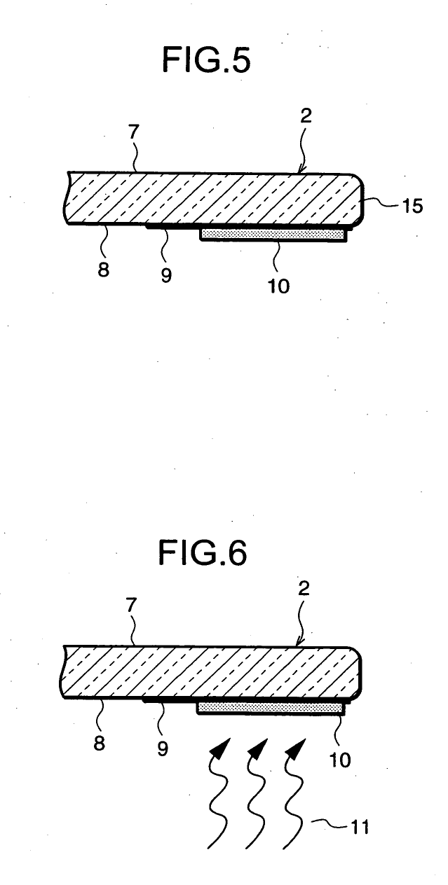

In FIGS. 1 to 4 and 7 reference numeral 1 denotes a preformed gasket adapted to be bonded on a car laminated glass windscreen. This car laminated glass windscreen is denoted by the reference numeral 2 in FIGS. 5 to 7. Gasket 1 is made of a thermoplastic polymer, for example PVC.

A first step of the process according to the invention to bond gasket 1 on windscreen 2 comprises coating a surface portion of the gasket 1 with a film 3 (FIG. 2) of a thermoplastic priming composition (advantageously a thermoplastic elastomer such as a chlorinated polypropylene).

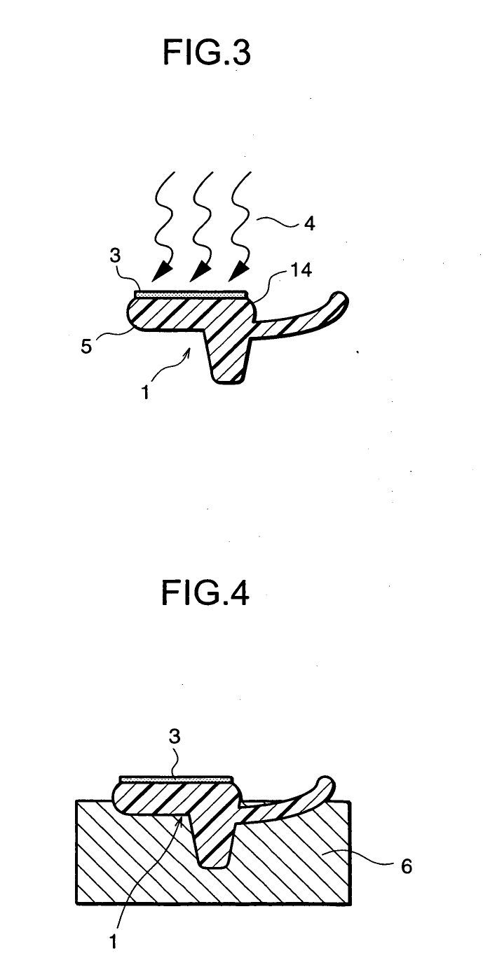

In a second step (FIG. 3) the film 3 of priming composition is subjected to heating 4. This heating consists in treating the film 3 with a stream of hot air at substantially 600° C. with a controlled flow-rate and during a controlled time to have a temperature of from substantially 150° C. to substantially 180° C. in the film 3 and in the surface portion 14 of gasket 1, which contacts film 3 (this surface portion 14 being defined above) avoiding any substantial heating of the core 5 of the gasket. This treatment of film 3 with hot air is continued during a sufficient time to evaporate substantially all the solvent of the film 3 of thermoplastic priming composition and to slightly soften both the film 3 and surface portion 14 of gasket 1. This softening of the film 3 and of the surface portion 14 of gasket 1 acts to promote a mutual interaction between molecules of film 3 and molecules of surface portion 14 of gasket 1, which induces an adhesive strength of film 3 to gasket 1.

After heating the film 3 at the requested temperature, this film 3 is allowed to cool to the ambient temperature and the gasket 1 is disposed in an appropriate frame 6 (FIG. 4).

Alternatively, the gasket 1 is disposed in frame 6 just after heating 4 and the film 3 is allowed to cool in frame 6.

According to another alternative, the gasket 1 is disposed in the frame 6 before (or after) coating with film 3 and both the heating 4 and the cooling are operated when the gasket 3 is in frame 6.

The panel or windscreen 2 illustrated in FIGS. 5, 6 and 7 may be a tempered, laminated or otherwise strengthened glass sheet. It has two substantially parallel faces 7 and 8 which terminate in a peripheral edge 15. A ceramic frit layer 9 is applied and bonded to a restricted peripheral area of face 8.

The process according to this invention comprises further coating the marginal portion of the ceramic frit layer 9 with a film 10 of the same priming composition as film 3.

After film 10 has been applied on frit layer 9 the glass panel 2 is treated (as illustrated in FIG. 6) with a source of heat 11 to heat glass panel 2, frit layer 9 and film 10 to an adequate substantially uniform temperature ranging from substantially 80 to substantially 120° C. Treating the glass panel 2 with the source of heat 11 may advantageously be executed in an appropriate furnace. This treatment of glass panel 2 with the source of heat 11 is continued during a sufficient time heat the panel 2, evaporate the solvent of the film 10 and slightly soften this film 10.

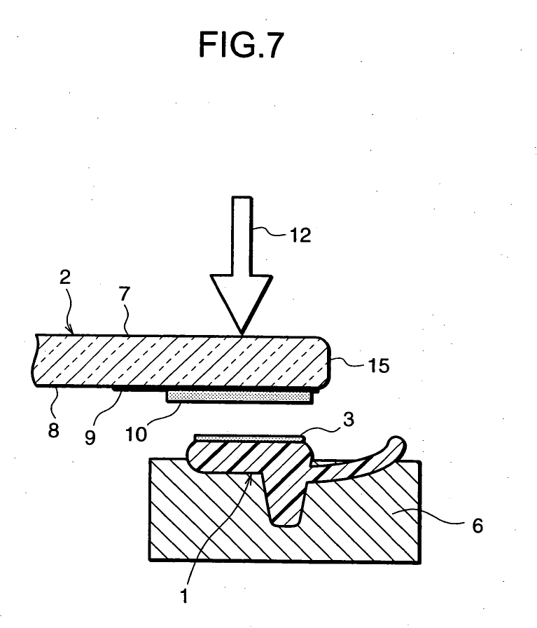

In this step of the process the hot panel 2 constitutes a thermal mass which maintains the film 10 at the required temperature during the time necessary to bring the panel 2 into contact with the gasket 1. This bringing of panel 2 into contact with gasket 1 is illustrated in FIG. 7. The gasket 2 being located in the frame 6, the panel 1 is deposited on the gasket 2 in such a manner that both the film 10 and the film 3 of priming composition come into contact with one another. Panel 2 is forced with pressure against gasket 1 by means of strength 12.

This pressure is maintained during a sufficient time to promote a mutual interaction between molecules of both the film 3 the film 10 to induce an strong anchorage of both films.

Finally the assembly of glass panel 2 with gasket 1 is cooled to the ambient temperature before or after removing from frame 6.

In the panel assembly manufactured as illustrated in FIGS. 2 to 7, the ceramic frit layer 9 acts to cosmetically conceal the gasket 1. Alternatively the gasket 1 may be fixed directly to the panel 2 if ceramic frit layer 9 is not used. In this alternative embodiment of this invention, the film 10 of priming composition is directly applied on face 8 of the glass panel 2.

In the embodiment illustrated on FIGS. 1 to 7 and just described the film 3 of priming composition is let cool on gasket 1 within the surrounding atmospheric air. In an alternative embodiment, the film 3 is subjected to a controlled flow of cold air (or another gas) at a controlled temperature.

In another embodiment of this invention the film 3 of priming composition is not cooled or let cool before bringing and pressing the panel 2 thereon.

In another, not illustrated, modified embodiment of this invention a second gasket, similar to or different from gasket 1 is bonded to the peripheral portion of the face 7 of the panel 2. This bonding of this second gasket to face 7 of the panel 2 are similar to those described hereabove with respect to the bonding of gasket 1 to the face 8 of the panel 2.

The entire disclosure of European Patent Application No. 03101392.3 filed on May 16, 2003 including specification, claims, drawings and summary is incorporated herein by reference in its entirety.

What is claimed is:

1. A method of manufacturing a panel assembly comprising bringing a preformed thermoplastic gasket (1) into contact with a panel (2), a priming composition being interposed between both the gasket and the panel and subjected to heating, characterised in that said priming composition comprises a film (3) of priming composition which is coated on the gasket (1) and a film (10) of priming composition which is coated on the panel (2), and in that said heating is performed in two separate steps before bringing said gasket into contact with said panel, said steps comprising a step of heating said film (3) of priming composition on the gasket (1) and a step of heating said film (10) of priming composition on the panel (2).

2. Method according to claim 1, comprising subjecting said film (3) of priming composition to cooling on the gasket (1) after said step of heating said film of priming composition on the gasket and before bringing said gasket (1) into contact with said panel (2).

3. Method according to claim 1, characterised in that said step of heating the film (3) of priming composition on the gasket (1) is so executed as to prevent substantial heating of a core (5) of the gasket (1) and said step of heating the film (10) of priming composition on the panel (2) is so executed as to have said panel hot when bringing said gasket into contact with said panel.

4. Method according to claim 3, characterized in that said step of heating said film (3) on the gasket (1) comprises sweeping said film (3) with a stream of a hot gas (4) and said step of heating said film (10) on the panel (2) comprises heating the panel (2) in a furnace (11).

5. Method according to claim 1, characterized in that bringing said gasket (1) into contact with said panel (2) comprises forcing with pressure (12) the panel (2) into contact with the gasket (1).

6. Method according to claim 1, characterised in that said heating (4) of the film (3) of priming composition on the gasket (1) is performed at a temperature of from 100 to 200° C. and said heating (11) of the film (10) of priming composition on said panel (2) is performed at a temperature of from 75 to 120° C.

7. Method according to claim 1, characterised in that a is same priming composition is used for both films (3, 10) of priming composition.

8. Method according to claim 1, characterised in that said gasket (1) is made in a thermoplastic material selected from amongst the olefinic thermoplastic polymers, the olefinic thermoplastic copolymers, the chlorinated thermoplastic polymers, the chlorinated thermoplastic copolymers and the thermoplastic elastomers and said panel (2) is a glass panel.

9. A panel assembly including a glass panel (2) and a gasket (1) of a thermoplastic elastomer material bonded on a surface (8) of said glass panel, characterized by a linear bonding strength of said gasket on said panel which is at least than 35 N/cm.

10. Panel assembly according to claim 9, characterized in that said bonding strength of said gasket (1) on said panel (2) is at least equal to 40 N/cm.

11. Panel assembly according to claim 10, characterized in that said bonding strength of said gasket (1) on said panel (2) is at least equal to 50 N/cm.

12. A panel assembly obtained by a method according to claim 1.

13. Panel assembly according to claim 9, for use as window in a vehicle.
